(19) United States
(12) Patent Application Publication
(10) Pub. No.: US 2013/0067318 A1
(43) Pub. Date: Mar. 14, 2013

(54) APPARATUS AND METHOD FOR SYNCHRONIZING A WORKING ENVIRONMENT

(71) Applicant: Dong Hun SEO, Seoul (KR)

(72) Inventor: Dong Hun SEO, Seoul (KR)

(73) Assignee: PANTECH CO., LTD., Seoul (KR)

(21) Appl. No.: 13/593,034

(22) Filed: Aug. 23, 2012

(30) Foreign Application Priority Data
Sep. 9, 2011 (KR) 10-2011-0091884

(51) Int. Cl. G06F 17/00

(52) U.S. Cl. 715/234

(57) ABSTRACT

An apparatus includes: a web storage acquisition unit to acquire web storage information, the web storage information comprising a key and a value; a storage query unit to accept a search term to query the web storage information; a working environment restoration unit to restore a working environment of the web-enabled apparatus, wherein the storage query unit queries the web storage information, and if the search term matches the key, the working environment restoration unit restores the working environment. A method includes: acquiring web storage information, the web storage information comprising a key and a value; querying the web storage information with a search term; and if the search term matches the key, restoring the working environment.

### CROSS-REFERENCE TO RELATED APPLICATION

This application claims priority from and the benefit under 35 U.S.C. §119(a) of Korean Patent Application No. 10-2011-0091884, filed on Sep. 9, 2011, which is incorporated by reference for all purposes as if fully set forth herein.

### BACKGROUND

1. Field

Exemplary embodiments of the present invention relate to the synchronization of a working environment, and specifically, to a web-enabled device that retrieves web storage information to restore and synchronize a working environment and a method for the same.

2. Discussion of the Background

The World Wide Web first introduced the concept of the Hypertext Markup Language (HTML). HTML was not standardized when first introduced; however, several web browsers, such as, Mosaic, Netscape, and Internet Explorer implemented various web techniques utilizing individual nuances of HTML. The World Wide Web Consortium (W3C) was established by companies and associations related to the web. Standardization institutions, such as the W3C, ISO, and IETF, have defined standards for common web techniques, such as HTML and CSS, which allow a standard implementation of these concepts as agreed upon by various web browser manufactures. Internet Engineering Task Force (IETF) issued an HTML 2.0 standards proposal in 1995, and the W3C issued an HTML 3.2 standards proposal in January, 1997. Furthermore, HTML 4.0 issued by the W3C became the basis for HTML 4.01, issued on December 1999. HTML 5 follows HTML 4.01, and is also being drafted as a standard for implementation.

Web developers have not fully implemented the storing of a working environment data in a client. One data storage technique is a cookie of the Hyper Text Transfer Protocol (HTTP). A Cookie refers to a small sized (4 KB or less) file which contains information that connects a web site and a user's computer. If an Internet user accesses a specific web page, the web page delivers information about the web page to the web browser of the user. The information is stored in the user's web browser and, if the same web page is accessed again, the information informs a web server of information of the user. Cookies may contain various information, such as, a personal ID, a password, and a visited site, and are stored in a client computer. However, a cookie may have a relatively small storage capacity (4 KB), and the maximum number of cookies that may be stored for one site may be small, such as 20. Further, the cookie's data format is a character string, and may not contain more complex data, such as JAVA Script. Further, if a cookie is set for a web site, all requests for that website after the setting are transmitted to a server along with the cookie information. Accordingly, there may be a security problem that stored cookies are exposed and transmitted to a server, and transmitting this extra information increases network traffic. Further, if the same site is searched using one or more tabs in one browser, there may be a difficulty in tracking two or more tabs. Further, the cookie has a unique effective period expiration date by user designation.

Korean Unexamined Patent Publication No. 2010-68825 and Korean Patent Registration No. 10-923161 disclose a method of the contents of a working environment being performed through a web application being stored and restored. This implementation is not done in conjunction with any standards. However, only a simple working environment may be stored and restored, and a working environment may be exposed to the outside, and a server's traffic load may increase.

### SUMMARY

Exemplary embodiments of the present invention provide an apparatus and method for synchronizing a working environment, and specifically a working environment that may be applicable to a HTML 5 web browser of a web enabled device.

Additional features of the invention will be set forth in the description which follows, and in part will be apparent from the description, or may be learned by practice of the invention.

An exemplary embodiment of the present invention discloses a web-enabled apparatus, including: a web storage acquisition unit to acquire web storage information, the web storage information comprising a key and a value; a storage query unit to accept a search term to query the web storage information; a working environment restoration unit to restore a working environment of the web-enabled apparatus, wherein the storage query unit queries the web storage information, and if the search term matches the key, the working environment restoration unit restores the working environment.

An exemplary embodiment of the present invention discloses a method for synchronizing a working environment, comprising: acquiring web storage information, the web storage information comprising a key and a value; querying the web storage information with a search term; and if the search term matches the key, restoring the working environment.

An exemplary embodiment of the present invention discloses a method for retrieving web storage information, comprising: connecting to a terminal via a communication technique; loading the web storage information on the terminal; retrieving the web storage information of a first browser; determining if a second browser is being executed; if the second browser is being executed, retrieving the web storage information of the second browser; and storing the retrieved web storage information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a mobile apparatus communicating over a network according to an exemplary embodiment of the present invention.

FIG. 2 is a diagram illustrating web storage information according to an exemplary embodiment of the present invention.

FIG. 3 is a diagram illustrating a mobile apparatus according to an exemplary embodiment of the present invention.

FIG. 4 is a flowchart illustrating method for storing web storage information according to an exemplary embodiment of the present invention.

FIG. 5 is a flowchart illustrating a method for restoring the working environment according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

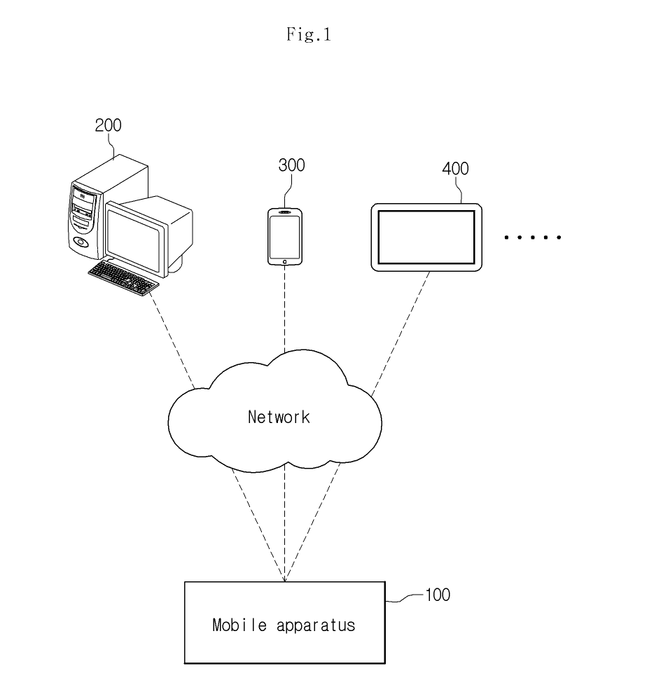

FIG. 1 is a diagram illustrating a mobile apparatus communicating over a network according to an exemplary embodiment of the present invention.

Referring to FIG. 1, a mobile apparatus 100 obtains working environment information of a first web system, and uses this working information to synchronize a user working environment of a second web system.

A web system refers to any system connected to the Internet or a communication network and able to exchange information through the Internet or communication network. The web system may include a computer system 200, a server (not shown), a smart phone 300, or a smart pad 400, and the like.

The mobile apparatus 100 may be implemented in various ways, and it may include various characteristics. For example, the mobile apparatus 100 may be a processing device, such as a cellular device, a Personal Digital Assistant (PDA), a digital camera, a digital camera of a mobile telephone, and a portable computer, or may be a simple USB device. The mobile apparatus 100 may be a smart phone that includes one or more of a display, a touch sensor, a motion sensor, a vibrator, a speaker, a communication module, etc., or may be a smart pad or tablet. Further, the mobile apparatus 100 may include, for example, a processing system equipped with a processor, an operating system, and an Application Program Interface (API), that may provide communication between one or more applications and the operating system. Further, the processing system of the mobile apparatus 100 may execute a variety of software applications. The mobile apparatus 100 may communicate with another external system, including the computer system 200, the smart phone 300, and the smart pad 400 and may utilize or contain hardware or software for performing communication embedded therein. The communication may be performed by one or more communication techniques, such as a Near Field Communication (NFC), a Local Area Network (LAN), a wireless LAN, a Metropolitan Area Network (MAN), a Global System for Mobile (GSM) network, Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, a Voice over Internet Protocol (VoIP), World Interoperability for Microwave Access (Wi-MAX), and ultrasonic utilization communication, and the like.

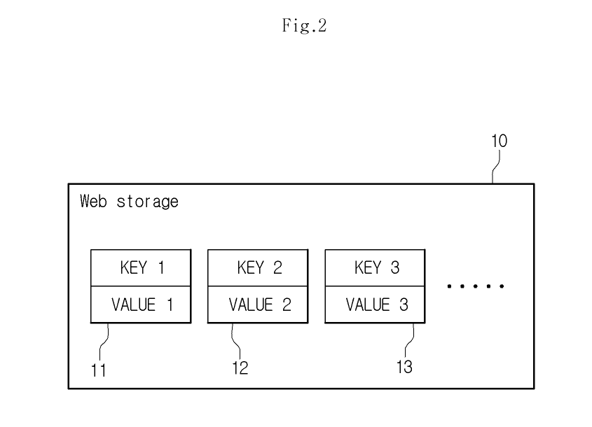

FIG. 2 is a diagram illustrating web storage information according to an exemplary embodiment of the present invention.

Referring to FIG. 2, the web storage 10 is a web application storage space that stores the data of a web browser. The concept of web storage 10 has been standardized by the World Wide Web Consortium (W3C). The web storage 10 may be implemented along various browsers, such as, Internet Explorer 8, Firefox 3.3 (that is, a browser based on Mozilla), Safari 4, Google Chrome 4, and Opera 0.50. The web storage 10 provides a storage space having a potentially unlimited capacity, versus the cookie, which has a capacity of 4 KB. The web storage 10 may include various information, such as a user password, context and data to be gathered and stored for a web application, and information for a streaming service to be used.

The web storage 10 is operated by the client through the usage of scripting, and thus, unlike an implementation using cookies, a server may not access this information. Data stored in the web storage 10 is not transmitted whenever an HTTP request is made, and a web server may not access the web storage 10 and may not write, read, and request to read data. This aspect of the web storage 10 may provide for better security, versus using a cookie.

The web storage 10 also provides a local storage and a session storage based on region and validity information. Data placed in the local storage is stored for every domain and may be retained after a browser is closed. On the other hand, the session storage is stored in each page of a browser, and the session storage is stopped if a browser window is exited. Unlike in cookies, in the session storage, the data of the same web application operated in separate browser windows or tabs are separated from each other, so that they are not influenced by a different browser, browser window, or tab.

Referring again to FIG. 2, internal data of the web storage 10 consists of several KEY entries (that is, work state information about the web browser) and several VALUE entries, each associated with a KEY value. The work state information may include an application operating state, data being worked on, a work document file, a work page position, the sequence and positions of applications being worked on a screen, an opened page of a web browser and the position of the page, favorites, a list of opened addresses, a music file being executed in a media player, a list of music files, and so on. The KEY entry is a unique value for searching for the VALUE entry, and may be based on a previously defined relation. The VALUE entry stores information corresponding to the KEY entry. For example, if the working environment information is gathered in a web browser on which a web application called Google Map is being operated (i.e. a navigation web site or application), web documents of the following listed type may be obtained. The KEY entry may have been previously set.

TABLE 1

| KEY | VALUE |
|---|---|
| “App Name” | “Google Map” |
| “Start Position” | “SEOUL” |
| “Destination” | “BUSAN” |
| . . . | . . . |

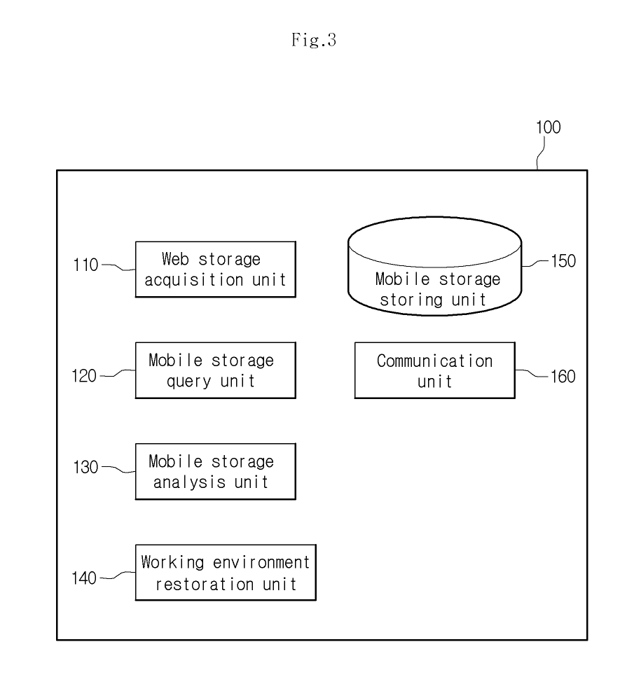

FIG. 3 is a diagram illustrating a mobile apparatus according to an exemplary embodiment of the present invention.

The mobile apparatus 100 may include a web storage acquisition unit 110, a mobile storage query unit 120, a mobile storage analysis unit 130, a working environment restoration unit 140, a mobile storage storing unit 150, and a communication unit 160.

The web storage acquisition unit 110 obtains a plurality of information of the type associated with web storage 10, which may be stored on the working environments of a plurality of browsers of a first web system. The mobile storage acquisition unit 110 requests the web browser of the first web system to deliver the web storage 10 information, receives the web storage 10 information obtained from the web browsers of the first web system, and stores the received web storage 10 in a mobile storage query unit 120. Here, the mobile storage query unit 120 may be implemented along with a web application for gathering, storing, and managing the relevant web storage 10 information. If there is a plurality of browsers used in the first web system, the mobile storage query unit 120 obtains a plurality of the web storage 10 information of the plurality of browsers. Unlike in the cookie implementation, all the browsers can be restored because information about each web storage 10 for each of the plurality of browsers is not browser specific. Further, even when several tabs exist in one web browser, all or a partial amount of the working environment information about the plurality of tabs may be stored.

The working environment restoration unit 140 may utilize the above stored information from the mobile storage storing unit 150 if a restoration or synchronization of data is performed.

The mobile storage query unit 120 functions to query the information of the mobile storage storing unit 150, in which the various web storage 10 information is stored. A variety of VALUE entries according to various KEY entries of a plurality of browsers and tabs stored in a mobile storage storing unit 150 may be checked, regardless of whether working environment information has been synchronized with another web system.

The mobile storage analysis unit 130 analyzes information contained in the mobile storage storing unit 150. More particularly, the mobile storage analysis unit 130 may determine working environment information of a user associated with the stored information based on the unique key entries of the web storage 10.

The working environment restoration unit 150 displays the same working environment of the first web system based on HTML 5 in a second web system based on HTML 5 on the basis of the analyzed information of the mobile storage analysis unit 130. More particularly, the working environment restoration unit 140 displays the same working environment of the first web system based on HTML 5 in the second web system based on HTML 5 on the basis of the KEY entries. Here, the second web system may be the mobile apparatus 100 itself, or may be another web system capable of communicating with the mobile apparatus via the communication unit 160. If the second web system is the mobile apparatus 100, the working environment is synchronized based on the information contained in the mobile storage storing unit 150, without performing communication. If the second web system is an external web system, the mobile apparatus requests the external web system to restore the working environment information. Accordingly, the working environment information may be synchronized with the second web system.

The communication unit 160 may perform communication by using one or more communication techniques, such as a wireless Local Area Network (LAN), a Metropolitan Area Network (MAN), a Global System for Mobile (GSM) network, Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, a Voice over Internet Protocol (VoIP), World Interoperability for Microwave Access (Wi-MAX), and ultrasonic utilization communication. A similar communication unit 160 may be implemented in any other device, such as the devices shown in FIG. 1, and be able to receive synchronization information from the mobile apparatus 100.

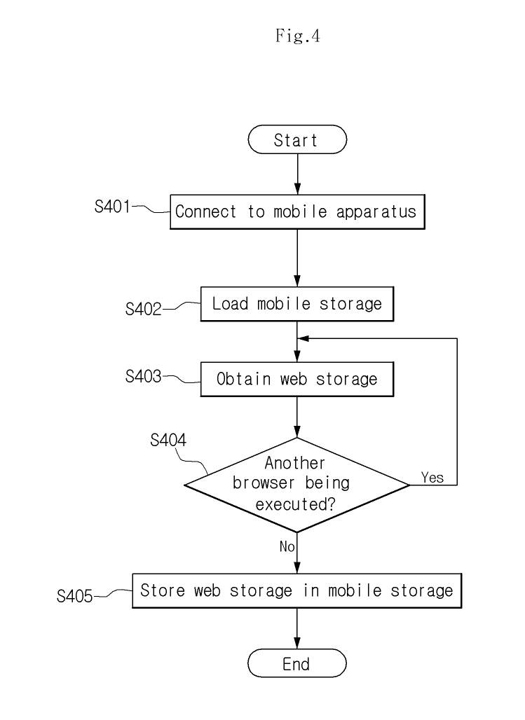

FIG. 4 is a flowchart illustrating method for storing web storage information according to an exemplary embodiment of the present invention.

The first web system and a mobile apparatus connect to each other in operation S401. The connection may be performed using any one of a variety of communication techniques, such as, contactless near-field wireless communication using NFC. After connection, the mobile apparatus may request the web browser of the first web system for the first web system web storage information (operation S402), and thus, may receive the web storage information in operation S403. If a plurality of browsers or tabs are used in the first web system, the mobile apparatus retrieves web storage information for the additional browsers or tabs at operation S404. Operations 403 and 404 may be done recursively until information for each browser or tab is obtained. A mobile storage is generated based on the obtained web storage at operation S405.

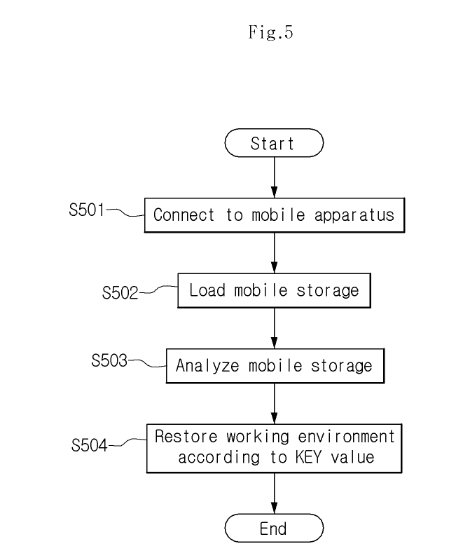

FIG. 5 is a flowchart illustrating a method for restoring the working environment according to an exemplary embodiment of the present invention.

A second web system and a mobile apparatus connect with each other at operation S501. This may be performed through any one of a variety of communication techniques, including those described above, such as, through contactless near-field wireless communication using NFC. If the working environment information is sought to be synchronized through a browser used within the mobile apparatus, the operation S501 may be omitted. In this case, the mobile apparatus serves also as the second web system in the description that follows. Information contained in a mobile storage is loaded at operation S502. Specifically, the working environment information of a first web system stored is loaded. The working environment information may be loaded in the mobile apparatus based on a technique shown in FIG. 4. The mobile storage information loaded in operation 502 is analyzed at operation S503. For example, in performing the analysis, the second web system may determine information about the first web system from analyzing the various KEY entries. Thus, the unique KEY entries associated with the operation of a user may allow a second web system to ascertain the state and operation state of a user. The working environment of the second web system is restored like the working environment of the first web system through the mobile storage which has been analyzed based on the unique KEY entries, and their corresponding VALUE entries at operation S504. Accordingly, the working environment information of a first web system can be synchronized with the second web system.

Thus, based on the above, work and environments of a first web system can be seamlessly transitioned if a user uses a second web system. Further, an entire or partial user working environment information can be stored and restored irrespective of a capacity and an effective period in a standard web environment based on HTML 5. Further, information about a working environment of a user may not become exposed to an outside network environment. Moreover, a traffic load of a server may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A web-enabled apparatus, comprising:
a web storage acquisition unit to acquire web storage information, the web storage information comprising a key and a value;
a storage query unit to accept a search term to query the web storage information;
a working environment restoration unit to restore a working environment of the web-enabled apparatus,
wherein the storage query unit queries the web storage information, and if the search term matches the key, the working environment restoration unit restores the working environment of the web-enabled apparatus.

2. The apparatus according to claim 1, wherein the web storage information is based on a HTML 5 standard.

3. The apparatus according to claim 2, further comprising:
a communication unit to communicate the web storage information to and from a second web-enabled apparatus.

4. The apparatus according to claim 2, further comprising:
a storage analysis unit to analyze the web storage information,
wherein the working environment restoration unit restores the working environment based on the analyzed web storage information.

5. The apparatus according to claim 4, wherein the web storage information comprises a plurality of keys, and the storage analysis unit analyzes the web storage information by analyzing the keys.

6. The apparatus according to claim 2, wherein the web storage information stores information for at least two web browsers.

7. The apparatus according to claim 2, wherein the web storage information stores information for at least two tabs of a single web browser.

8. The apparatus according to claim 2, wherein the web-enabled apparatus is one of a: a cellular device, a Personal Digital Assistant (PDA), a digital camera, a digital camera of a mobile device, a portable computer, and a USB device.

9. The apparatus according to claim 3, wherein the communication unit communicates according to one of the following: a Near Field Communication (NFC), a wireless Local Area Network (LAN), a Metropolitan Area Network (MAN), a Global System for Mobile (GSM) network, an Enhanced Data GSM Environment (EDGE), a High Speed Downlink Packet Access (HSDPA), a Wideband Code Division Multiple Access (W-CDMA), a Code Division Multiple Access (CDMA), a Time Division Multiple Access (TDMA), a Bluetooth, a Zigbee, a Wi-Fi, a Voice over Internet Protocol (VoIP), a World Interoperability for Microwave Access (Wi-MAX), and an ultrasonic utilization communication.

10. A method for synchronizing a working environment, comprising:
acquiring web storage information, the web storage information comprising a key and a value;
querying the web storage information with a search term; and
if the search term matches the key, restoring the working environment.

11. The method according to claim 10, wherein the web storage information is based on a HTML 5 standard.

12. The method according to claim 11, further comprising:
receiving the web storage information via a communication technique.

13. The method according to claim 11, further comprising:
analyzing the web storage information; and
restoring the working environment based on the analyzed web storage information.

14. The method according to claim 13, wherein the web storage information comprises a plurality of keys, and the storage analysis unit analyzes the web storage information by analyzing the keys.

15. The method according to claim 11, wherein the web storage information stores information for at least two web browsers.

16. The method according to claim 11, wherein the web storage information stores information for at least two tabs of a single web browser.

17. The method according to claim 11, wherein the communication technique is at least one of: a Near Field Communication (NFC), a wireless Local Area Network (LAN), a Metropolitan Area Network (MAN), a Global System for Mobile (GSM) network, an Enhanced Data GSM Environment (EDGE), a High Speed Downlink Packet Access (HSDPA), a Wideband Code Division Multiple Access (W-CDMA), a Code Division Multiple Access (CDMA), a Time Division Multiple Access (TDMA), a Bluetooth, a Zigbee, a Wi-Fi, a Voice over Internet Protocol (VoIP), a World Interoperability for Microwave Access (Wi-MAX), and an ultrasonic utilization communication.

18. A method for retrieving web storage information, comprising:
loading the web storage information on the terminal;
retrieving the web storage information of a first browser;
determining if a second browser is being executed;
if the second browser is being executed, retrieving the web storage information of the second browser; and
storing the retrieved web storage information.

19. The method according to claim 18, wherein the web storage information is based on a HTML 5 standard.

20. The method according to claim 18, further comprising connecting to a terminal via a communication technique.
